(19) United States
(12) Patent Application Publication
(10) Pub. No.: US 2002/0116707 A1
(43) Pub. Date: Aug. 22, 2002

(54) Streaming media client system and method

(76) Inventors: Richard M. Morris, Woodinville, WA (US); Todd Greenwalt, Kirkland, WA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/956,481

(22) Filed: Sep. 18, 2001

Related U.S. Application Data
(60) Provisional application No. 60/254,708, filed on Dec. 11, 2000.

(51) Int. Cl. H04N 7/08; G06F 3/00; H04N 5/445; H04N 7/087; G09G 5/00; H04N 7/084; G06F 13/00

(52) U.S. Cl. 725/37; 348/474; 725/51; 345/700; 345/760

(57) ABSTRACT

A client system and method for real-time rendering of digital content from a network. The invention includes a digital media engine configured to receive and process the digital content, and a media gateway that hosts a user interface web page. The web page includes user-selectable controls, preferably associated with one or more client-side scripts or control programs. The user-selectable controls enable navigation of the network, and control of the digital media engine. The system further includes a media control interface connecting the digital media engine and the media gateway, via the user interface web page and control programs provided thereby.

### STATEMENT OF RELATED APPLICATIONS

This application claims the benefit of U.S. Provisional Application No. ______, filed Dec. 10, 2000 and entitled “TECHNIQUE FOR CONTROLLING STREAMING MEDIA CONTENT FROM A VARIETY OF SERVERS AND SOURCES,” which is incorporated herein in its entirety. This application also relates to U.S. patent application Ser. No. ______, filed Oct. ______, and entitled “USER INTERFACE FOR A STREAMING MEDIA CLIENT,” which is incorporated by reference herein for all purposes.

### BACKGROUND OF THE INVENTION

The demand for real-time streaming digital media is exploding. Real-time streaming digital media includes video on demand (VoD) services, network audio channels, and other types of near-instantaneous selectable and rendered media types.

Users can now access video files from the internet. However, in order to be displayed seamlessly and without degrading artifacts, the entire file usually must first be downloaded and stored locally, and then accessed and processed from the local storage. The total time to download and process a file can be excessively, and unacceptably, large.

Another type of real-time digital media service includes cable or satellite television and movies-on-demand. However, such systems do not provide simultaneous access to other network services, such as advertising, electronic commerce (e-commerce), or internet access.

Just as the demand for real-time digital media is exploding, so are the types and formats of digital media content. For instance, most video files stored on the Internet were encoded and compressed according to MPEG-1 or MPEG-2 standards and protocols. New media types, such as MPEG-4, are being used. Further, new media-rich languages are being utilized for network communications, such as extensible markup-language (XML) and dynamic HTML (DHTML).

### BRIEF DESCRIPTION OF THE DRAWING

FIG. 1 is a simplified block of a digital media client system in accordance with the invention.

FIG. 2 shows a digital media client system according to a specific embodiment of the invention.

FIG. 3 is a functional block diagram of a digital media client system, according to the invention.

### DETAILED DESCRIPTION OF THE PREFERRED EMBODIMENTS

This invention provides a client system for providing real-time, high quality multimedia services, and methods of the same. The systems and methods of the invention are particularly suited for real-time rendering of digital content, of any media type, from a network. According to one embodiment, the invention includes a digital media engine configured to receive and process the digital content. The embodiment also includes a media gateway that hosts a user interface web page. The web page includes user-selectable controls, preferably associated with one or more client-side scripts or control programs. The user-selectable controls enable navigation of the network, and control of the digital media engine. The invention further includes a media control interface connecting the digital media engine and the media gateway, via the user interface web page and control programs provided thereby.

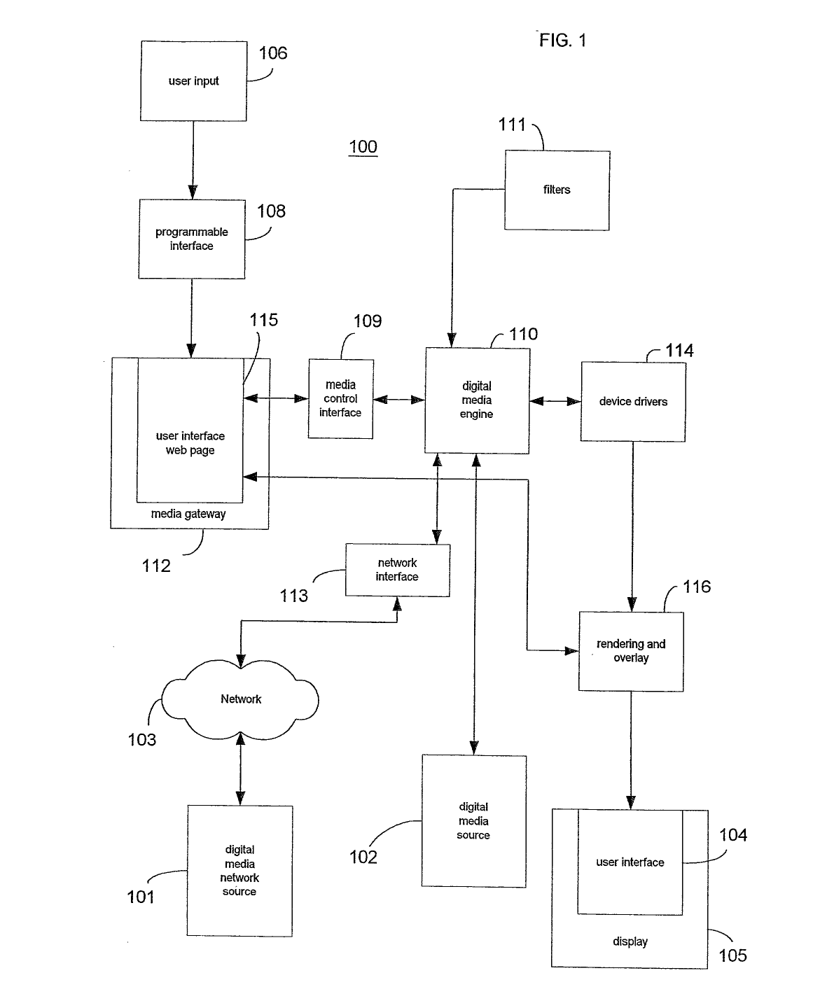

FIG. 1 shows a simplified block diagram of a multimedia client system 100. The multimedia client system 100 receives a number of types of digital media from various digital media sources 101, 102. One such digital media source can be a video server 102, such as a video on demand (VOD) server. The video server 102 stores a copy of a digital file, such as a video or audio file, in an accessible memory location associated with the video server 102. The digital media is accessed from the video server 102, typically in accordance with a particular protocol, after which it transmits the selected digital media to the system 100.

The communication medium from the video server 102 to the rest of the system 100 can be a direct link. For instance, the video server 102 may comprise a digital media storage device, such as a digital video disk player, and the hardware and software employed to allow the video server 102 to be accessed and send the requested media. The video server 102 may also be remotely located, accessible via a network.

The digital media source can also be a network server 101, such as an IP multicast broadcast server. A network server 101 is configured to stream digital media over a network 103 according to a specific network protocol. Streaming media over the Internet, for example, is typically done in accordance with the Internet Protocol (IP) for packet-based transmission. The network server 101 is connected through the network 103 via a network interface 113. Other types of digital media and digital media sources may be used. The digital media sources described herein are for example only.

The video server 102 and/or network server 101 can form what is known as an Interactive Broadband Entertainment Services (IBES) network. The IBES network communicates to the client system 200 according to IP over an Ethernet or Asynchronous Transmission Mode (ATM) network.

The digital media is processed by parts of the system 100 and delivered to a display 105. The user interface 104 is rendered within the display 105. Suitable devices for the display include, without limitation, video graphic displays such as a television, computer monitor, flat-panel display screen, liquid crystal display (LCD), or any other device that is adapted to visually render graphics and video.

The system 100 further includes a user input 106 for receiving input signals from a user. The user input signals can be commands, requests, instructions, etc. The user input 106 includes one or more user input devices, including, without limitation, keyboard, keypad, lightpen, mouse, track-ball controller, handheld remote keyboard or keypad, wireless device, optical device, etc. The user input 106 may also include a card swipe reader for receiving credit card and/or financial information. The user input 106 is preferably used in conjunction with the user interface 104, and in one embodiment can include being rendered as a part of the user interface 104. For instance, user-controllable function buttons can be rendered as graphics or links within the user interface 104. The functions provided by the user interface 104 and controllable by the user input 106 are preferably based on web-browser functionality.

Signals from the user input 106 are provided to a programmable interface 108, which can include a programmable interface card (PIC) and associated PIC services software. The programmable interface 108 is responsible for communicating with the input/output hardware sub-systems, including peripheral user input devices that comprise the user input 106.

The system 100 also includes a media gateway 112, through which user control data is communicated. In one embodiment, the media gateway 112 includes a software program that provides a communication interface between client-side computer programs and computer programs residing on a network. The media gateway 112 includes a web browser application. The browser application is preferably one of several commercially-available browsers that supports a wide range of multimedia capabilities, such as Internet Explorer™ from Microsoft Corporation, or Netscape Navigator™ from Netscape.

The media gateway browser hosts a user interface web page 115. The user interface web page 115 renders mark-up language-based information, such as hypertext markup language (HTML), dynamic HTML (DHTML), or extensible markup language (XML), which is used for interactive communication between the user and the media source via the programmable interface 108. The user interface web page 115 forms the user interface 104 as a set of browser-based control functions, and is hosted by a web browser provided by the media gateway, thereby providing browser-in-browser functionality.

As stated above, the user interface web page 115 provides a graphical user interface with user controls rendered with HTML, DHTML, or XML tags, and which are displayed on the user interface 104. The user interface web page 115 can be generated locally by the media gateway 112, or downloaded from a remote server, and then rendered by the media gateway 112. The user interface web page 115 provides controls for directing the operation of any of the digital media sources through a media control interface 109.

The media control interface 109 preferably includes a computer program configured to communicate input and control signals between the user interface web page 115 and the digital media engine. The media control interface 109 receives user input based on the user interface controls, and sends control signals to a digital media engine 110 based on the user input. The digital media engine 110 executes the user input to access, receive and process the digital media, and renders the processed media on the user interface 104. When the user interface web page 115 is generated by the media gateway, the user interface can persist even in the event of a terminated network connection.

The media gateway 112 can include control objects, such as ActiveX control XKeys or Java™ applets for example, that are provided to the user interface web page 115 and executed to perform one or more functions. One such function is to trap keystrokes and mouse movements passed by the programmable interface 108. These, in turn, are processed by the same or other control objects for controlling the digital media engine 110. The media gateway 112 can also include several program tools that make the system 100 scalable for receiving and processing other types of user commands.

The digital media engine 110 includes a number of services that enable playback of audio and video, or other content, to the user interface 104, and which control and instantiate a number of different types of filter graphs provided by source filter module 111. A filter graph is a self-contained software program configured for performing one or more digital media processing functions, such as parsing content from the digital media for further processing, for example. Specific filter graphs are employed, individually or as a group, depending on the type of digital media that is to be processed. The digital media engine 110 also includes other processing modules, including, but not limited to, cipher engines such as encoders, decoders, demodulators, or compression and/or decompression engines. Each of these processing modules can be implemented in hardware, firmware, or in software. FIG. 1 merely illustrates one example of a digital media retrieval system in accordance with the invention.

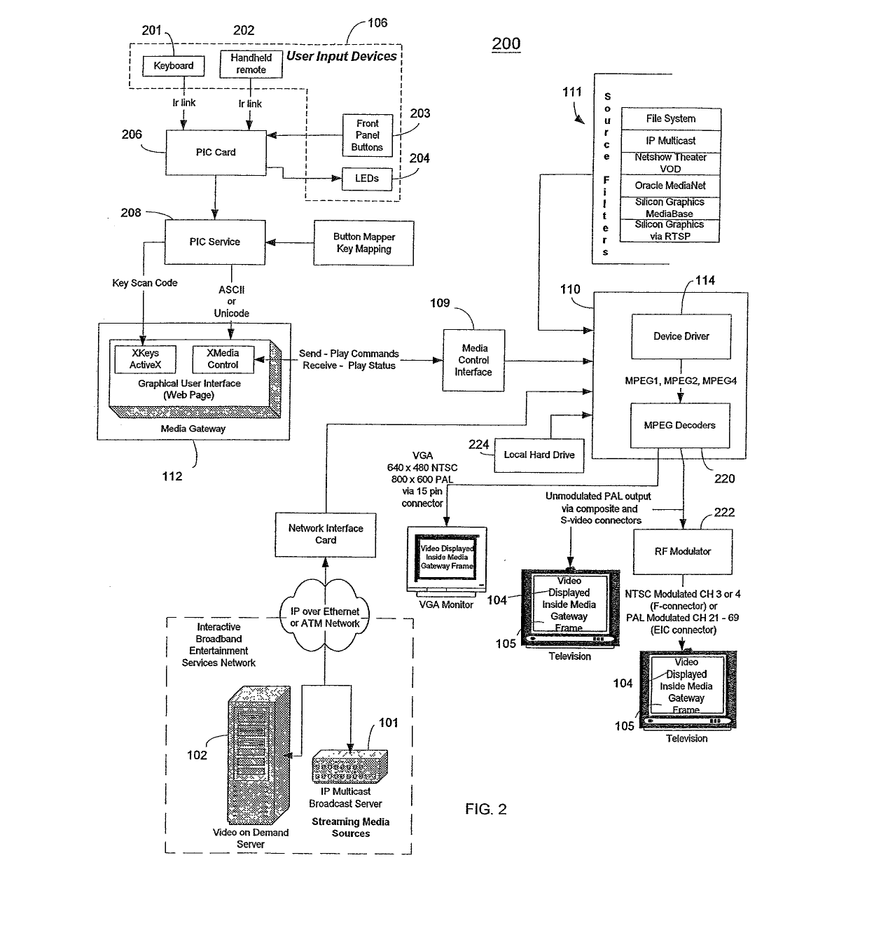

FIG. 2 illustrates, in further detail, one embodiment 200 of a digital media retrieval system in accordance with the invention. The user input 106 can include a keyboard 201 having a number of keys for alphanumeric and numeric data entry. The keyboard may also have a uniform surface that provides one or more activatable key areas. The user input 106 can also include a handheld remote control 202 having a number of finger-controlled keys. The keyboard 201 and/or handheld remote control 202 may communicate with the programmable interface 108 via data cable or wirelessly with infrared signals.

The user input 106 can include buttons 203 located on panel connected to the device which houses the system 200. The panel could also include light emitting diodes (LEDs) 204 configured to provide the user with control and status information. It should be readily apparent that other devices or arrangements could be part of the user input 106, and not limited to the devices or arrangements described herein. For instance, the user input may also include one or more peripheral devices such as a mouse, barcode, light source, or microphone, or may have alternative user communication interfaces, such as a liquid crystal display (LCD), switches, or dials, etc.

The programmable interface 108 includes a programmable interface card (PIC) 206 for receiving user input from the primary control inputs of the keyboard 201 and handheld remote 202, or from any other device that forms the user input 106. The programmable interface card 206 is connected with a PIC service module 208. In a preferred embodiment, the PIC service module 208 is part of the system software containing a key controls subsystem 205, which provides key trapping, remapping of special function keys from the primary control inputs, and filtering of certain key sequences. The PIC service module 208 also includes software to translate mapped keystrokes into associated key scan codes, or to provide the user input as ASCII or unicode data.

The user inputs are provided to the TV Gateway 112 for controlling the user interface web page 115, which is preferably a dHTML page, but can also include HTML or XML tags. The user interacts with the system 200 through the web page 115. In a preferred configuration of the system 200, user inputs, represented as key scan codes for example, are processed by an ActiveX control file called XKeys 210 or other equivalent software component, to determine the desired action associated with the user input. The XKeys file 210 also interacts with the media gateway 112 to re-render the user interface web page 115 for example, or process the action represented by the scan key codes.

The user interface web page 115 also includes an ActiveX control file called XMedia 212, from which the digital media is controlled according to the user input. The XMedia control 212 receives the user input and executes the action desired. It should be understood that ActiveX controls are merely one type of control program that can be employed by the system 200 for receiving and processing user input, and for controlling the digital media, and that other types of control programs can be used within the scope of the invention.

The user interface web page 115 is configured to render user controls. Some of the user controls may be web-browser based controls of the type used with a conventional web browser application, including BACK, FORWARD, STOP, REFRESH, etc. The user controls also allow the user to select content to be retrieved. For instance, the web page 115 can display a list of video titles, and the user can initiate playing of a selected video by clicking on one or more of the titles. The media gateway 112 then passes the video title, initializes the server, activates any special playback parameters, sets the video display parameters, and starts the video. The media gateway 112 provides the digital video as an SVGA graphics overlay on the playing, decoded video stream.

The source filter module 111 includes one or more filters, and preferably a large number of filters 211 that are accessed upon command from the media gateway 112, based on the processing requested by the user. The filters 211 can be commercially-available filters from one of several vendors. In a specific example, a source filter configured for a specific media source communicates with a server that hosts a media file, and directs the server to begin streaming the content of the media file over the network (or from a local server). A renderer filter can communicate with a processing board that is specifically configured to process a certain type of media, such as MPEG-1, MPEG-2 and MPEG-4 audio and video, for example. Filters can be designed to present various media formats. For example, a transform filter can act as an interface between the renderer filter and other third-party or proprietary source filters. The filters are formed into a filter graph, and controlled by a filter graph manager, explained in further detail below.

In the exemplary embodiment 200, the device driver 114 is connected with the digital media engine 110 for driving an output of a particular decoded media type. As stated above, the client system 200 is configured to support various media types, including, for example, MPEG-1, MPEG-2, and MPEG-4 media streams. Other types of media can be supported within the scope of the invention. According to the embodiment, an MPEG processing card 220 is used to receive the decoded MPEG stream and outputs the stream in any desired display format. For instance, one output of the MPEG card 220 can be a 15-pin VGA connector. The VGA output includes 640×480 NTSC, or 800×600 PAL. Another output could include unmodulated PAL via composite and/or S-video connectors. Still another output could pass through an RF modulator 222 for NTSC modulated video via F-connector, or PAL modulated video via EIC female connector. Those with relevant skill in the art would recognize that still other output formats are possible. Further, the functionality of the MPEG card 220 can be implemented in software or firmware according to alternative embodiments.

The output from the MPEG decoders 220 is blended with a web page hosted by the media gateway, to render a user interface 104 video displayed inside the media gateway frame, as a display 105. The display 105 can be generated by the unmodulated PAL output to a television, or by the NTSC modulated output to a television. Other mechanisms for generating the display 105 are possible, such as VGA via 15-pin connector, formatted to NTSC or PAL.

The digital media engine 110 also includes other processing modules, including, but not limited to, cipher engines such as encoders/decoders, demodulators, and compression/decompression-executing engines. Each of these processing modules can also be implemented in hardware, firmware, or in software.

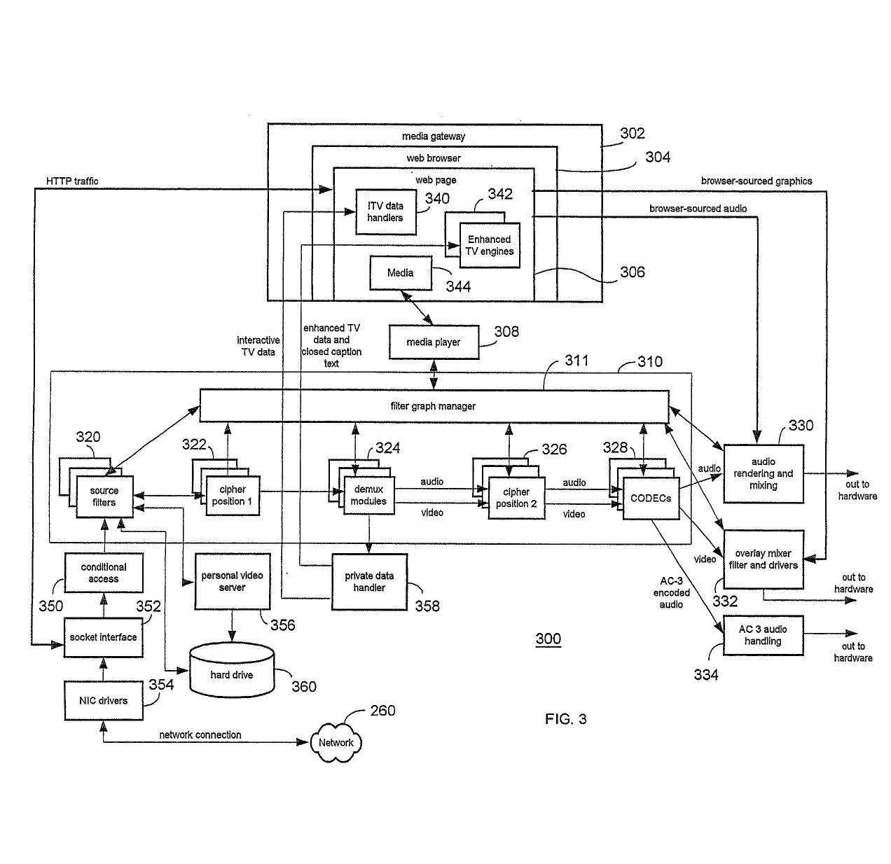

FIG. 3 shows a functional block diagram of a multimedia client system 300 according to another embodiment. Each of the blocks in the system 300 can be implemented in hardware, firmware, or as software. For example, digital signal processing (DSP) can be accomplished using an application specific integrated circuit (ASIC) that is particularly suited for a sole DSP task. Alternatively, a general purpose computer processor, running at high processing clock speeds can be programmed to accomplish DSP functions. A hardware implementation of the system 300 can have any type of suitable configuration, and accordingly this invention does rely on any specific hardware. A software implementation of the system 300 can be hosted by any operating system, such as Windows or Linux for example.

The system 300 includes a media gateway 302, a top-level application program that generates a window for displaying control graphics and video. The media gateway 302 includes a web browser application program that contains an instance of a web browser 304 and associated controls, such as Microsoft's Internet Explorer™ and its IE WebBrowser controls, respectively. The web browser 304 hosts a web page 306 that provides connectivity to the World Wide Web (hereinafter, the “Web”) via one or more user-selectable graphical links. The Web is a network of HTTP-compliant data locations distributed among the Internet, and at least one of those data locations in the Web is a digital media source from which selected digital media is downloaded for display. The user-selectable graphical links represent browser-type user controls. Accordingly, the user interface provides a browser-within-browser configuration.

The web page 306 includes one or more control programs 340, 342, and 344, each of which is preferably a self-contained client-side script. The control programs 340, 342, and 344 are independently configured for, among other functions, generating graphical or text-based user controls in the user interface, for generating a display area in the user interface as directed by the user controls, or for displaying the processed streaming media. The control programs 340, 342, and 344 can be implemented as ActiveX controls, as Java applets, or as any other self-contained and/or self-executing application, or portion thereof, operable within a media gateway 302 container environment and controllable through the web page 306.

Internet content is displayed within a frame in the web page 306. In an embodiment, the web page 306 provides one or more instances of an ActiveX control. ActiveX refers to a set of object-oriented programming technologies and tools provided by Microsoft Corporation of Redmond, Wash. The core part of the ActiveX technology is the Component Object Model (COM). A program run in accordance with the ActiveX environment is known as a “component,” a self-sufficient program that can be run anywhere in the network, as long as the program is supported. This component is known as an “ActiveX control.” Thus, an ActiveX control is a component program object that can be re-used by many application programs within a computer or among computers in a network, regardless of the programming language with which it was created. An ActiveX control runs in what is known as a container, an application program utilizing the COM program interfaces.

One advantage of using a component is that it can be re-used by many applications, referred to as “component containers.” Another advantage is that an ActiveX control can be created using one of several well-known languages or development tools, including C++, Visual Basic, or PowerBuilder, or with scripting tools such as VBScript. ActiveX controls can be downloaded as small executable programs, or as self-executable code for Web pages animation for example. Similar to ActiveX controls, and suitable for the client-side scripts, are applets. An applet is typically a self-contained, self-executing computer program written in Java™, a web-based, object-oriented programming language promulgated by SUN Microsystems Corp. of Sunnyvale Calif.

The control programs 340, 342, and 344 can be stored and accessed locally at the client system 300, or downloaded from the network 360. Downloading is typically done by encapsulating a control program in one or more markup language-based files. The control programs can also be used for any commonly-needed task by an application program running in one of several operating system environments. Windows, Linux and Macintosh are operating system environments that can be used.

The control programs provide functionality to enhance the user's experience. The number and type of control programs is not limited to those described herein. For instance, one control programs can include interactive television (ITV) data handlers 340 for interactive communication with the digital media, enhanced television engines 342 for providing features such as recording and playback, and a media module 344, for media processing. Other functionality is possible through the use of other control programs.

The media module 344 provides access from the web page 306 to a digital media engine 310 for controlling the playback of digital video and audio, launching multicast, broadcast TV, and/or other streaming video services supported by the client system 300. For instance, video on demand (VoD) functions can be controlled from a single DHTML web page 306 that contains the media module 344 and the client-side script with which it interfaces. Streamed and decoded video is viewed through the web page 306, which is transparent to the user even though the user interacts with the system 300 through the web page.

The media module 344 with a media player 308 to control the digital media engine 310. The media player 308 is a hardware-independent application program that interprets commands from the media module 344, with which to control a filter graph manager 311. The filter graph manager 311 controls how a filter graph is assembled from source filters 320, and how data is moved through the assembled filter graph. The media player 308 directs the filter graph manager 311 to construct an appropriate filter graph for a particular media format specified by user input through the media module 344. The media player 308 also provides an interface to the filter graph manager 311 to add proprietary filters, either to the source filters 320 or to an assembled filter graph.

Source filters 320 are registered for preferential or default loading, and to present the correct filter type for compatibility with the media type. Blocks 322, 324, 326, and 328 in FIG. 3 represent filters and/or processing modules which the filter graph manager 311 controls, or through which the filter graph manager 311 monitors data. Cipher position 1 modules 322 perform a block cipher routine on encrypted multiplexed digital media. Demultiplexing modules 324 demultiplexes the transport stream of a multiplexed digital media stream. Cipher position 2 modules 326 perform a second block cipher routine on encrypted, demultiplexed digital media. The cipher modules 322 and 326 form portions of a decoder, for decoding encoded digital media received by the system 300.

Compression/decompression (CODEC) modules 328 decompress a compressed digital media stream. The CODEC modules 328 are scalable to include various types of CODEC algorithms for any media type, and can be implemented specifically in hardware or software. For example, MPEG-1 and MPEG-2 decompression algorithms are preferably performed with specific dedicated CODEC hardware chips. However, an MPEG-4 software module can be activated to decompress a compressed MPEG-4 stream. Other CODEC algorithms performed by the CODEC modules 328 can include wavelet-based compression, True Motion™ VP3 promulgated by On2.com, Inc., and compression algorithm provided by TeraNex, Inc. Other proprietary or open CODECs can be employed. The filter graph manager 311 directs which CODEC module 328 is appropriate for a particular digital media type.

In one specific exemplary embodiment, the web page 306 provides a list of video titles. The user can click on one, or more, video titles, which selection is interpreted by the media module 344. The media module 344 will then pass the selected video title to the source, initialize the source, activate any special playback parameters including the appropriate filter graph, set the video display parameters, and start the playback of the selected video. The system 300 provides a digital video SVGA graphics overlay on top of the playing, decoded MPEG video stream. This digital overlay is then reformatted to NTSC or PAL, and then output to the appropriate hardware. For example, the digital overlay can be rendered in 24-bit, 640×480 pixel resolution for NTSC, and 800×600 for PAL.

The control programs 340, 342, and 344 provided by the user interface web page 306 can be configured to operate on data provided by the private data portion of a digital media packet cell. For instance, the MPEG-2 transport cell includes a cell header, a video section including a video section header, an audio section including an audio section header, and a private data section including a private data section header. The video section contains encoded video content, encoded according to MPEG-1 or -2 encoding standards. The video content is arranged in packets, called the “payload.” The audio section includes MPEG-3 encoded audio packets. The private data section includes packets of data having no use restrictions. Accordingly, the private data section can include, by way of example and not limitation, closed-captioning data, teletext data, or even web page data for generating an XML-coded web page for the web page 306.

The user interface of this invention adds robust web browsing functionality to the media gateway 302 web browser 304. The user interface web page 306 calls methods and handles events that can navigate to any other web page through a link. The combination of the media gateway 302 and user interface forms a “browser-in-browser” architecture. The browser-in-browser architecture provides Internet access on a TV platform. The web page 306 provides a graphical user interface (GUI) that is displayed within the media gateway application frame. Internet content is displayed within a frame in the web page 306. The control programs 340, 342 and 344 monitor network integrity during operation. If network integrity is compromised, the user interface 306 will redirect user control to a default or customized error handling page.

A frameset and frames collection, which provides access to the individual frames, is preferably written in HTML or DHTML code. Each frame is an instance of the media gateway browser window, so the object model for windows is also applicable to each frame. Techniques available for manipulating windows can also be used for manipulating the frames.

According to a specific exemplary embodiment, scripting languages and visual tools use an abstracted interface to the ActiveX controls. This interface is called the IDispatch interface and simplifies calling methods and getting and setting properties. To access the user interface methods, events, or properties from a web page, the user interface must be instantiated and visible on the web page.

The system 300 includes an audio rendering and mixing block 330 for mixing browser or web-based audio from the web page 306 with processed digital media audio from the digital media engine 310. An overlay mixer filter 332 performs the overlay of web browser-based, user control graphics onto the decoded video stream from the CODEC modules 328, and provides the composite picture for display. In the absence of a video stream, the web browser graphics can be displayed independently, or as a standard web browser graphical interface which hosts a web page.

The system 300 is preferably connected to a network 360. The connection is made to the system through a network interface card (NIC) and NIC drivers 354 to a standard Winsock interface 352, through which two-way hypertext traffic is transmitted. A conditional access module 350 is provides secure access to the system 300 and source filters 320 therein. The conditional access module 350 can be a software program that verifies a user based on conditional data including, without limitation, a user name and/or password. The network connectivity is used for receiving digital media from the network 360, such as, for example, the Web or local area network.

For local access and downloading of digital media, a personal video server 356 can be connected with the system. The personal video server 356 stores one or more video files, and can be implemented on the same platform as the rest of the system, or on a separate platform connected via a data bus. A hard drive 360 may also be provided for long term storage of client-side scripts, source filters, digital media files, or executable code for use by the system 300.

The system further can include a private data handler 358. The MPEG-2 transport cell includes a private data section that can contain data in addition to the encoded video and audio data. The MPEG-2 standards do not restrict the nature of this data and the private data section of the MPEG-2 transport cell is used in a number of different ways. For example, closed captioning data is typically carried in the private data section. Other types of data can also be used to create “enhanced TV” graphics that are rendered and overlain upon the video images. For this additional data to be interpreted and rendered as intended, it must be parsed out of the private data section, identified, and handed off to the appropriate software module for rendering.

The MPEG-2 Transport demux module 324 parses the data out of the private data section of the MPEG-2 Transport Cell and passes this data to the private data handler 358 software module. The private data handler 358 attempts to identify the nature of this data by a sorting process. When the data is identified as a specific type, the private data handler 358 then passes the data to the appropriate software module for rendering.

The additional data parsed from the private data section will fall into one of 3 broad categories: closed captioning data, Enhanced TV graphics data, and Interactive TV application data. Closed captioning data will be passed to an enhanced TV engine 342 that can convert the data into text graphics. Enhanced TV graphics data will be passed to an enhanced TV engine 342 that can convert the data into graphics. Both closed captioning and enhanced TV text and graphics will be rendered by the web browser and overlain onto the decoded video as described in FIG. 1. Interactive TV application data will be passed to an Interactive TV data handler 340 that can interact with other parts of the streaming media client system software.

An AC 3 audio handler 334 for AC-3 encoded digital audio is provided. The AC-3 encoded digital audio can be handled in three different ways: it can be passed in digital form to an external AC-3 decoding device over an S/PDIF connector, it can be decoded by hardware and passed in analog form to speakers over up to 5 RCA connectors, or it can be decoded by software and passed in analog form to speakers over up to 5 RCA connectors. The AC-3 audio handler 334 performs one of these three functions, depending upon the design of the streaming media client.

Other embodiments, combinations and modifications of this invention will occur readily to those of ordinary skill in the art in view of these teachings. Therefore, this invention is to be limited only be the following claims, which include all such embodiments and modifications when viewed in conjunction with the above specification and accompanying drawings.

What is claimed is:

1. A client system for real-time rendering of digital content from a network, comprising:
a digital media engine configured to receive and process the digital content;
a media gateway that hosts a user interface web page which includes user-selectable controls for navigating the network and for controlling the digital media engine; and
a media control interface configured to receive user input signals based on the user-selectable controls, and to send control signals to the digital media engine according to the user input signals.

2. The system of claim 1, wherein the digital media engine includes a decoder for decoding an encoded digital content signal.

3. The system of claim 1, wherein the digital media engine includes a demultiplexer for demultiplexing a multiplexed digital content signal.

4. The system of claim 1, wherein the digital media engine includes one or more CODECs for decompressing one or more types of compressed digital content signals.

5. The system of claim 1, wherein the digital media engine includes a filter graph manager for retrieving and managing one or more filters in a filter graph.

6. The system of claim 5, wherein the one or more filters in the filter graph are configured to process the digital content.

7. The system of claim 1, wherein the media gateway provides a top-level web browser that hosts the user interface web page.

8. The system of claim 1, wherein the user-selectable controls form a graphical user interface.

9. The system of claim 1, wherein the user-selectable controls are generated by markup language tags served with the user interface web page.

10. The system of claim 9, wherein the markup language tags are associated with one or more control programs, and wherein each control program is configured to execute a control function.

11. The system of claim 10, wherein the control programs are ActiveX controls.

12. The system of claim 10, wherein the control programs are Java™ scripts.

13. The system of claim 1, wherein the user interface web page includes a graphical user interface.

14. The system of claim 13, wherein the graphical user interface is provided by one or more client-side scripts included with the user interface web page.

15. The system of claim 1, further comprising an audio rendering and mixing module, configured to combine audio signals from the digital media engine and the media gateway, and render the combined audio signals to a user display.

16. The system of claim 1, further comprising an overlay mixer filter, configured to overlay the user interface web page onto the processed digital content, and render the overlaid image to a user display.

17. The system of claim 1, further comprising a conditional access module that provides secure access to the system by a user.

18. The system of claim 1, further comprising a network interface, connected to the digital media engine and the media gateway, for communicating with the network.

19. The system of claim 1, wherein the media gateway includes one or more control programs associated with the user-selectable controls.

20. The system of claim 1, further comprising a local storage medium connected with the digital media engine, for storing digital content control programs for controlling the processing of the digital content.

21. A client system for real-time rendering of digital content from a network, comprising:
a video subsystem including a rendering engine configured to receive and process the digital content, and to render the processed digital content for a user display;
a network subsystem including a media gateway that hosts a user interface web page which includes user-selectable controls for navigating the network and for controlling the video subsystem; and
a media control interface having a first interface for receiving user input signals based on the user-selectable control programs, and a second interface for sending control signals to the video subsystem according to the user input signals.

22. The system of claim 21, further comprising a network interface configured to communicate internet data between the network and the network subsystem.

23. The system of claim 22, wherein the network interface is further configured to communicate digital content signals between the network and the video subsystem.

24. The system of claim 21, wherein the digital media engine further includes:
a plurality of filters, each configured to perform a digital content processing function; and
a filter graph manager, configured to assemble one or more filters into a filter graph for a particular digital content type, and to manage the filter graph for processing digital content base on the digital content type.

25. The system of claim 24, wherein the plurality of filters include at least one decoder filter.

26. The system of claim 24, wherein the plurality of filters include at least one demultiplexer filter.

27. The system of claim 24, wherein the plurality of filters include at least one CODEC program.

28. The system of claim 21, wherein the media gateway provides a top-level web browser that hosts the user interface web page.

29. The system of claim 28, wherein the user interface web page provides a graphical user interface, and wherein the user-selectable controls include web-browser type controls.

30. The system of claim 29, wherein the graphical user interface is superimposed on the rendered digital content on the user display.
